(19) United States
(12) Patent Application Publication
(10) Pub. No.: US 2009/0156755 A1
(43) Pub. Date: Jun. 18, 2009

(54) Crosslinkable Silicone Coating Compositions

(75) Inventors: Christian Herzig, Waging (DE); Martina Joachimbauer, Haiming (DE); Hans Lautenschlager, Haiming (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/328,795

(22) Filed: Dec. 5, 2008

(30) Foreign Application Priority Data
Dec. 17, 2007 (DE) 10 2007 055 844.0

(51) Int. Cl. B05D 3/10; C08G 77/38

(52) U.S. Cl. 525/478; 427/387

(57) ABSTRACT

Crosslinkable silicone coating compositions are prepared from
(1) organopolysiloxanes containing alkenyl groups and containing per molecule at least one unit

O_{3-n/2}RₙSi—Y(SiRₙO_{3-n/2})ₐ (I),

at least 2 units

R¹R_{b}SiO_{(3-b)/2} (II),

and units

R_{c}SiO_{(4-c)/2} (III),

where
R is a monovalent, SiC-bonded organic radical having 1 to 30 C atoms free from aliphatic carbon-carbon multiple bonds, R¹ is an alkenyl radical having 2 to 4 C atoms, and Y is a divalent or trivalent organic radical having 1 to 30 C atoms,
with the proviso that the organopolysiloxanes (1) contain units (II) in amounts wherein the concentration of alkenyl radicals R¹ is less than 2 meq/g,
(2) organopolysiloxanes containing Si-bonded hydrogen atoms,
(3) a hydrosilylation catalyst, and
(4) optionally, inhibitors.
   The compositions cure rapidly with few extractables and are very useful in preparing release coatings.

### BACKGROUND OF THE INVENTION

1. Field of the Invention

The invention relates to crosslinkable silicone coating compositions and to their use.

2. Background Art

U.S. Pat. No. 5,241,034 describes siloxanes which are branched via hydrocarbon bridges and which contain SiC-bonded ω-unsaturated groups. These ω-unsaturated groups are relatively long-chain alkenyl groups, preferably 5-hexenyl groups, via which these siloxanes can be crosslinked in a Pt-catalyzed reaction with organohydrogenpolysiloxanes. A hydrosilylation reaction is used to prepare these branched siloxanes as well, where the Pt-catalyzed reaction sequence follows essentially statistical laws. With the described technique it is possible to prepare multi-alkenyl-functional organopolysiloxanes.

U.S. Pat. No. 5,616,672 discloses fast-crosslinking formulations which comprise siloxanes that have terminal alkenyl groups and that are branched via regular T units of the formula RSiO_{3/2}. The incorporation of these T units at a sufficient rate is possible only by way of base-catalyzed operations, which rules out the widespread acid-catalyzed processes.

A similar situation occurs with the formulations of WO 2005/005544 Al, composed of alkenyl-terminated siloxanes branched by Q units, these formulations likewise achieving high crosslinking rates. Again, only basic preparation operations are suitable for the synthesis, and so this synthetic method cannot be generally used.

From U.S. Pat. No. 6,258,913 it is known that rapidly crosslinkable branched alkenylsiloxanes can also be prepared from alkenylsiloxanes and alkenyl-hydrogensiloxanes. However, this requires a hydrosilylation reaction whose implementation necessitates noble metal catalysts. The bridging units are composed of low molecular weight hydrocarbon structures.

WO 2007/023084 A2 describes organopolysiloxane compounds which comprise per molecule at least one structural unit of the general formula O_{3-a/2}RₐSi—Y(SiRₐO_{3-a/2})_{b}, where a is 1 or 2, b is an integer from 1 to 11, and Y is a 2- to 12-valent organic radical, and which are prepared via hydrolysis processes and cohydrolysis with silanes.

### SUMMARY OF THE INVENTION

An object of the invention was to provide crosslinkable silicone coating compositions which crosslink rapidly. A further object was to provide crosslinkable silicone coating compositions which produce coatings that repel tacky substances and have low release values. A further object was to provide crosslinkable silicone coating compositions which produce coatings that repel tacky substances and have low extract values, i.e., low proportions of extractable noncrosslinked silicone polymers. These and other objects are achieved by the invention, wherein addition curable branched carbosilane-containing organopolysiloxanes containing less than 2 meq/g of alkenyl groups are crosslinked via Si—H functional organosiloxanes in a hydrosilylation reaction.

### DETAILED DESCRIPTION OF THE PREFERRED EMBODIMENT(S)

The invention thus provides crosslinkable silicone coating compositions comprising
(1) organopolysiloxanes containing alkenyl groups and comprising per molecule at least one structural unit of the general formula

O_{3-n/2}RₙSi—Y(SiRₙO_{3-n/2})ₐ (I) and

at least 2 units of the general formula

R¹R_{b}SiO_{(3-b)/2} (II),

and units of the general formula

R_{c}SiO_{(4-c)/2} (III),
where
a is 1 or 2, preferably 1,
b is 0, 1 or 2, preferably 1 or 2,
c is 1, 2 or 3, preferably 2 or 3,
n is 0 or 1, preferably 1,
R at each occurrence may be identical or different and is a monovalent, SiC-bonded organic radical having 1 to 30 C atoms, which may contain one or more 0 atoms separate from one another and which is free from aliphatic carbon-carbon multiple bonds, and
R¹ is an alkenyl radical having 2 to 4 C atoms, preferably a vinyl radical,
Y is a divalent or trivalent organic radical having 1 to 30 C atoms,
with the proviso that the organopolysiloxanes (1) comprise units of the formula (II) in molar amounts such that the concentration of alkenyl radicals R¹ in organopolysiloxanes (1) is less than 2 meq/g (milliequivalents per gram of organopolysiloxane (1)),
(2) organopolysiloxanes containing Si-bonded hydrogen atoms,
(3) catalysts promoting the addition of Si-bonded hydrogen to aliphatic multiple bond,
   and if desired,
(4) inhibitors.

Preferably R is a monovalent, SiC-bonded hydrocarbon radical having 1 to 18 carbon atoms which is free from aliphatic carbon-carbon multiple bonds.

Examples of hydrocarbon radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as the the cyclopentyl, cyclohexyl, cycloheptyl, and methylcyclohexyl radicals; aryl radicals such as the phenyl, naphthyl, anthryl, and phenanthryl radicals; alkaryl radicals such as the o-, m-, and p-tolyl radicals, xylyl radicals, and ethylphenyl radicals; and aralkyl radicals such as the benzyl radical and the α- and the β-phenylethyl radicals. The hydrocarbons R may contain ether or polyether groups. Preferred examples of R are methyl, ethyl, and phenyl radicals.

Examples of radicals R¹ are the vinyl, allyl, and 3-butenyl radicals, the vinyl radical being a preferred example.

A preferred unit of the formula (II) is R¹R₂SiO_{1/2}, and preferred units of the formula (III) are R₃SiO_{1/2} and R₂SiO, where R is preferably a methyl radical and R¹ is preferably a vinyl radical. If R₃SiO_{1/2} units are present in organopolysiloxanes (1), the molar ratio of R¹R₂SiO_{1/2} units to R₃SiO0₁₂ units is preferably greater than 1, more preferably greater than 2, and most preferably greater than 3.

A preferred example of units of the formula (II) is therefore the vinyldimethylsiloxane unit. Preferred examples of units of the formula (III) are therefore trimethylsiloxane and dimethylsiloxane units. Organopolysiloxanes (1) preferably contain on average at least 3 alkenyl radicals R¹, more preferably at least 4 alkenyl radicals R¹, preferably in the form of R¹R₂SiO_{1/2} units (II).

The organopolysiloxanes (1) containing alkenyl groups preferably contain 1, 2, 3, 4 or 5 structural units of the formula (I) per molecule.

The organopolysiloxanes (1) containing alkenyl groups preferably contain at least 10 units of the formula (III), more preferably at least 50 units of the formula (III), and most preferably at least 80 units of the formula (III).

Since n in formula (I) preferably has the value 1, the structural unit (I) preferably has the formula ORSi—Y(SiRO)ₐ, where R, Y, and a have the definition stated therefor above.

Preferably, a in formula (I) has the value 1 and Y is a divalent organic radical.

Examples of Y are the methylene and methine groups, the 1,1-ethanediyl and 1,2-ethanediyl groups, and the 1,4-butanediyl and 1,3-butanediyl groups. Where Y contains at least 2 C atoms, this radical may also be unsaturated. Examples of such are radicals of the formula

—CH═CH— (cis or trans), —C(═CH₂)—, and —C≡C—.

Preferably Y is an organic radical having not more than 12 C atoms, more preferably having 2 C atoms. Examples of particularly preferred radicals are those of the formula

—CH₂CH₂—, —CH(CH₃)—, —CH═CH—, —C(═CH₂)—, and —C≡C—.

The concentration of alkenyl radicals R¹ in organopolysiloxane (1) is preferably 0.1 to 1.2 meq/g, more preferably 0.1 to 0.8 meq/g (meq/g=milliequivalents per gram of substance). The vicosity of the organopolysiloxanes (1) is preferably 50 to 5,000 mPa·s (25° C.).

Processes for preparing the organopolysiloxanes (1) are described in WO 2007/023084 A2, more particularly page 4 line 16 to page 6 line 6 (which is incorporated herein by reference).

One preferred process for the preparation of the compounds of the invention is the hydrolysis of compounds of the general formula (IV)

X₃₋ₙRₙSi—Y(SiRₙX₃₋ₙ)ₐ (IV),

where X is a hydrolyzable group and R, Y, a, and n are as defined above. Preferably X is a halogen, acid, or alkoxy group; more preferably X is a chlorine, acetate, formate, methoxy or ethoxy group.

Particular preference is given to a process in which there is cohydrolysis of compounds of the general formula (IV) with silanes of the general formula (V)

R²_{d}SiX_{4-d} (V),
where X is a hydrolyzable group,
R² is a radical R or R¹, and
d is 1, 2 or 3, preferably 2 or 3.

As silanes (V) it is preferred to use those of the formula R¹R₂SiX, where R, R¹, and X have the definition stated therefor above.

One preferred embodiment of the process is the preparation of the organopolysiloxanes (1) in two stages: A cohydrolysis of the compounds (IV) and (V) to prepare a concentrate, followed by an equilibration of this concentrate with organopolysiloxanes which do not contain the structural unit (I). In the equilibration it is possible as organopolysiloxanes to use those selected from the group consisting of linear organopolysiloxanes containing terminal triorganosiloxy groups, linear organopolysiloxanes containing terminal hydroxyl groups, cyclic organopolysiloxanes, and copolymers comprising diorganosiloxane and monoorganosiloxane units. Preference is given to using linear organopolysiloxanes containing terminal triorganosiloxy groups. Preferred examples thereof are copolymers comprising vinyldimethylsiloxane and dimethylsiloxane units, and copolymers comprising trimethylsiloxane and dimethylsiloxane units.

The equilibration produces the desired concentration of alkenyl radicals R¹ in the organopolysiloxane (1).

As organopolysiloxanes (2) containing Si-bonded hydrogen atoms it is preferred to use linear, cyclic or branched organopolysiloxanes comprising units of the general formula VI

$${R}_{e}^{3} {H}_{f} {SiO}_{\frac{4 - 3 - f}{2}} , \qquad ( VI )$$

where
R³ at each occurrence may be identical or different and is a monovalent, optionally substituted, hydrocarbon radical having 1 to 18 C atoms which is free from aliphatic carbon-carbon multiple bonds,
e is 0, 1, 2 or 3,
f is 0, 1 or 2,
and the sum of e+f is 0, 1, 2 or 3,
with the proviso that there are on average at least 3 Si-bonded hydrogen atoms.

Preferably the organosilicon compounds (2) contain at least 3 Si-bonded hydrogen atoms. As organosilicon compounds (2) it is preferred to use organopolysiloxanes of the general formula

HₕR³₃₋ₕSiO(SiR³₂O)ₒ(SiR³HO)ₚSiR³₃₋ₕHₕ (VII)
where R³ has the definition stated therefor above,
h is 0, 1 or 2,
o is 0 or an integer from 1 to 1500, and
p is an integer from 1 to 200,
with the proviso that there are on average at least 3 Si-bonded hydrogen atoms.

In the context of this invention, formula VII is to be understood such that o units —(SiR³₂O)— and p units —(SiR³HO)— may be distributed in any desired way in the organopolysiloxane molecule.

Examples of hydrocarbon radicals R apply fully to hydrocarbon radicals R³.

Examples of such organopolysiloxanes (2) are more particularly copolymers comprising dimethylhydrogensiloxane, methylhydrogensiloxane, dimethylsiloxane, and trimethylsiloxane units, copolymers comprising trimethylsiloxane, dimethylhydrogensiloxane, and methylhydrogensiloxane units, copolymers comprising trimethylsiloxane, dimethylsiloxane, and methylhydrogensiloxane units, copolymers comprising methylhydrogensiloxane and trimethylsiloxane units, copolymers comprising methylhydrogensiloxane, diphenylsiloxane, and trimethylsiloxane units, copolymers comprising methylhydrogensiloxane, dimethylhydrogensiloxane, and diphenylsiloxane units, copolymers comprising methylhydrogen-siloxane, phenylmethylsiloxane, trimethylsiloxane and/or dimethylhydrogensiloxane units, copolymers comprising methylhydrogensiloxane, dimethylsiloxane, diphenylsiloxane, trimethylsiloxane and/or dimethylhydrogensiloxane units, and copolymers comprising dimethylhydrogensiloxane, trimethylsiloxane, phenylhydrogensiloxane, dimethylsiloxane and/or phenylmethylsiloxane units.

The organopolysiloxanes (2) preferably possess an average viscosity of 10 to 1,000 mPa·s at 25° C., and organopolysiloxane (2) is used preferably in amounts of 0.5 to 3.5, more preferably 1.0 to 3.0, gram atoms of Si-bonded hydrogen per mole of alkenyl radical R¹ in the organopolysiloxane (1).

As catalysts which promote the addition of Si-bonded hydrogen to aliphatic multiple bonds, in the crosslinkable silicone coating compositions as well it is possible to use the same catalysts which may be used to promote the addition of Si-bonded hydrogen to an aliphatic multiple bond. The catalysts (3) preferably comprise a metal from the group of the platinum metals or a compound or a complex from the group of the platinum metals. Examples of such catalysts are metallic and finely divided platinum, which may be on supports such as silica, alumina or activated carbon, compounds or complexes of platinum, such as platinum halides, e.g., PtCl₄, H₂PtCl₆.6H₂O, Na₂PtCl₄.4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆.6H₂O and cyclohexanone, platinum-vinylsiloxane complexes, such as platinum-1,3-divinyl-1,1,3,3-tetramethyldisiloxane complexes with or without detectable inorganically bonded halogen, bis(gamma-picoline)platinum dichloride, trimethylenedipyridineplatinum dichloride, dicyclopentadieneplatinum dichloride, dimethyl sulfoxide-ethyleneplatinum(II) dichloride, cyclooctadieneplatinum dichloride, norbomadieneplatinum dichloride, gamma-picolineplatinum dichloride, cyclopentadieneplatinum dichloride.

The catalysts (3) are preferably used in amounts of 10 to 1000 ppm by weight (parts by weight per million parts by weight), more preferably 20 to 200 ppm by weight, calculated in each case as elemental platinum metal and based on the total weight of the organopolysiloxane compounds (1) and (2).

The crosslinkable silicone coating compositions may comprise agents which retard the addition of Si-bonded hydrogen to aliphatic multiple bond at room temperature, these agents being known as inhibitors (4). As inhibitors (4) it is possible, with the crosslinkable silicone coating compositions as well, to use all of the inhibitors which are useful for the same purpose.

Examples of inhibitors (4) are 1,3-divinyl-1,1,3,3-tetramethyldisiloxane, benzotriazole, dialkylformamides, alkylthioureas, methyl ethyl ketoxime, organic or organosilicon compounds having a boiling point of at least 25° C. at 1012 mbar (abs.) and at least one aliphatic triple bond, such as 1-ethynylcyclohexan-1-ol, 2-methyl-3-butyn-2-ol, 3-methyl-1-pentyn-3-ol, 2,5-dimethyl-3-hexyne-2,5-diol, and 3,5-dimethyl-1-hexyn-3-ol, 3,7-dimethyloct-1-yn-6-en-3-ol, a mixture of diallyl maleate and vinyl acetate, maleic monoesters, and inhibitors such as the compound of the formula

HC≡C—C(CH₃)(OH)—CH₂—CH₂—CH═C(CH₃)₂,

available commercially under the trade name “Dehydrolinalool” from BASF.

Where inhibitor (4) is included it is used advantageously in amounts of preferably 0.01% to 10% by weight, more preferably 0.01% to 3% by weight, based on the total weight of the organosilicon compounds (1) and (2).

Examples of further constituents which may be used in the crosslinkable silicone coating compositions are agents for adjusting the release force, additives reducing aerosol formation, organic solvents, adhesion promoters, and pigments.

Examples of agents for adjusting the release force of the coatings which repel tacky substances, produced using the compositions of the invention, are silicone resins comprising units of the formula

R⁴R³₂SiO_{1/2} and SiO₂,

known as MQ resins, where R⁴ is a hydrogen atom, a hydrocarbon radical R³, such as methyl radical, or an alkenyl radical R¹, such as vinyl radical, and R³ is as defined above, and the units of the formula R⁴R³₂SiO_{1/2} may be identical or different. The ratio of units of the formula R⁴R³₂SiO_{1/2} to units of the formula SiO₂ is preferably 0.6 to 2. The silicone resins are used preferably in amounts of 5% to 80% by weight, based on the total weight of the organosilicon compounds (1) and (2).

Examples of additives which reduce aerosol formation, also called antimisting additives, are branched siloxane copolymers, of the kind described for example in U.S. Pat. No. 6,764,712, more particularly column 1 line 57 to column 2 line 25 (incorporated by reference) and in US 7,238,755, more particularly column 2 line 8 to column 3 line 8 (incorporated by reference). Examples of organic solvents are petroleum spirits, e.g., alkane mixtures having a boiling range of 70° C. to 180° C., n-heptane, benzene, toluene and xylenes, halogenated alkanes having 1 to 6 carbon atoms such as methylene chloride, trichloroethylene, and perchloroethylene, ethers such as di-n-butyl ether, esters such as ethyl acetate, and ketones such as methyl ethyl ketone and cyclohexanone.

Where organic solvents are included they are used advantageously in amounts of preferably 10% to 90% by weight, more preferably 10% to 70% by weight, based on the total weight of the organosilicon compounds (1) and (2).

Although the sequence when mixing constituents (1), (2), (3), and, where appropriate, (4) is not critical, it has nevertheless been found appropriate in practice to add constituent (C), viz. the catalyst, last to the mixture of the other constituents.

The compositions of the invention are preferably crosslinked at 70° C. to 180° C., more preferably at 100 to 150° C. Energy sources used for crosslinking by heating are preferably ovens, examples being forced-air drying cabinets, heating tunnels, heated rollers, heated plates, or infrared thermal radiation.

Apart from heating, the compositions of the invention can also be crosslinked by irradiation with ultraviolet light or by irradiation with UV and IR light. Ultraviolet light used is usually that having a wavelength of 253.7 nm. On the market there are a large number of lamps which emit ultraviolet light having a wavelength of 200 to 400 nm and which preferentially emit ultraviolet light having a wavelength of 253.7 nm.

The invention further provides shaped bodies produced by crosslinking the compositions of the invention. The shaped bodies preferably comprise coatings, more preferably coatings which repel tacky substances. The invention further provides a process for producing coatings by applying crosslinkable compositions of the invention to the surfaces to be coated and then crosslinking the compositions.

The crosslinkable compositions of the invention are preferably used for producing coatings which repel tacky substances, e.g., for producing release papers. Coatings which repel tacky substances are produced by applying crosslinkable compositions of the invention to the surfaces that are to be made repellent to tacky substances and then crosslinking the compositions.

The application of the compositions of the invention to the surfaces to be coated, preferably surfaces to be made repellent to tacky substances, may be accomplished in any desired manner which is suitable and widely known for the production of coatings from liquid materials; for example, by dipping, brushing, pouring, spraying, rolling, printing, by means of an offset gravure coating apparatus, for example, blade or knife coating, or by means of an airbrush. The coat thickness on the surfaces to be coated is preferably 0.3 to 6 μm, with particular preference 0.5 to 2.0 μm.

The surfaces to be coated, preferably surfaces to be made repellent to tacky substances, which may be treated in the context of the invention, may be surfaces of any materials which are solid at room temperature and 1012 mbar (abs.). Examples of surfaces of this kind are those of paper, wood, cork, and polymer films, e.g., polyethylene films or polypropylene films, woven and nonwoven fabric of natural or synthetic fibers, ceramic articles, glass, including glass fibers, metals, polyethylene-coated paper, and boards, including those of asbestos. The abovementioned polyethylene may in each case be high-pressure, medium-pressure or low-pressure polyethylene. In the case of paper the paper in question may be of a low-grade kind, such as absorbent papers, including kraft paper which is in the raw state, i.e., has not been pretreated with chemicals and/or natural polymeric substances, and which has a weight of from 60 to 150 g/m², unsized papers, papers of low freeness value, mechanical papers, unglazed or uncalendered papers, papers which are smooth on one side owing to the use of a dry glazing cylinder during their production, without additional complex measures, and which are therefore referred to as “machine-glazed papers”, uncoated papers or papers produced from waste paper, i.e., what are known as recycled papers. The paper to be treated in accordance with the invention may also of course, however, comprise high-grade paper types, such as low-absorbency papers, sized papers, papers of high freeness value, chemical papers, calendered or glazed papers, glassine papers, parchmentized papers or precoated papers. The boards as well may be of high or low grade.

The compositions of the invention are suitable, for example, for producing release, backing, and interleaving papers, including interleaving papers which are employed in the production of, for example, cast films or decorative films, or of foam materials, including those of polyurethane. The compositions of the invention are also suitable, for example, for producing release, backing, and interleaving cards, films, and cloths, for treating the reverse sides of self-adhesive tapes or self-adhesive sheets or the written faces of self-adhesive labels. The compositions of the invention are additionally suitable for treating packing material, such as that comprising paper, cardboard boxes, metal foils and drums, e.g., cardboard, plastic, wood or iron, which is intended for storing and/or transporting tacky goods, such as adhesives, sticky foodstuffs, e.g., cakes, honey, candies, and meat; bitumen, asphalt, greased materials, and crude rubber. A further example of the application of the compositions of the invention is the treatment of carriers for transferring pressure-sensitive adhesive films in the context of what is known as the transfer process.

The compositions of the invention are suitable for producing the self-adhesive materials joined to the release paper, both by the offline method and by the inline method.

In the offline method, the silicone composition is applied to the paper and crosslinked, and then, in a subsequent stage, normally after the winding of the release paper onto a roll and after the storage of the roll, an adhesive film, present for example on a label face paper, is applied to the coated paper and the composite is then compressed. In the inline method the silicone composition is applied to the paper and crosslinked, the silicone coating is coated with the adhesive, the label face paper is then applied to the adhesive, and the composite, finally, is compressed.

In the case of the offline method the winding speed is governed by the time needed to render the silicone coating tack-free. In the case of the inline method the process speed is governed by the time needed to render the silicone coating migration-free.

The crosslinkable silicone coating compositions of the invention have the advantage that they crosslink rapidly and can therefore also be used in high-speed coating units. Accordingly they are suitable more particularly for use in coating units with cure times of preferably 0.5 to 15 seconds, more preferably of 1.5 to 18 seconds, in which the compositions of the invention can be applied at rates of 20 to 1600 m/min to the surfaces that are to be coated.

Furthermore, the crosslinkable silicone coating compositions of the invention have the advantage that coatings that repel tacky substances can be obtained with low release values and low extraction values. Low extraction values, i.e., low fractions of extractable noncrosslinked silicone polymers, are achieved even with short crosslinking times. Hence the transfer of the noncrosslinked fractions to the adhesive is avoided and thus the bond strength of the adhesive is retained.

Low release force is very important more particularly in the case of very thin label material, since it allows the use of more cost-effective materials. These low release values were hitherto not possible, or were possible only with damage to the adhesive at the same time as a result of high extraction fractions.

### Preparation of the Inventive Organopolysiloxanes (1):

a) Condensate comprising structural units (I) and (II):
270 g of vinyldimethylchlorosilane are mixed homogeneously with 96 g of a 1:1 adduct of hydrogenmethyldichlorosilane and vinylmethyldichlorosilane. This mixture is cohydrolyzed by dropwise addition of 750 ml of 5% strength HCl solution with ice cooling. Following phase separation, the resulting oligomer is washed twice each with water and with 2% strength bicarbonate solution. The virtually neutral oil is freed from volatiles at 3 mbar and 130° C.

This gives in addition to 144 g of divinyltetramethyldisiloxane as an oligomeric residue 107 g of a cohydrolysate of the chlorosilanes having a viscosity of 14.2 mm²/s (25° C.).

b) Equilibration of condensate and linear vinylsiloxane:
The stated amounts of the condensate prepared under a) and the amounts stated in table 1 of a linear vinylsiloxane comprising vinyldimethylsiloxy and dimethylsiloxy groups, with an average molecular weight of 12,600 Da, are mixed homogeneously and, following addition of 200 ppm of phosphorus nitrile chloride (in solution in 1.5 times the amount of ethyl acetate), the mixture is equilibrated to constant viscosity at 120° C. In the case of siloxane 1.4, half of the linear vinylsiloxane was replaced by a functionless silicone oil with the same chain length.
When constant viscosity is attained, the batch is deactivated with 1% MgO, filtered, and freed from volatiles under reduced pressure at 120° C.

For the organopolysiloxanes (1) containing vinyl groups, thus obtained, table 1 gives for each, the amount of structural units of the formula (I) (amount of (I) in mol %) and the concentration of vinyl groups (C═C content in meq/g).

The organopolysiloxanes (1) containing vinyl groups are used directly for the preparation of the inventive silicone coating compositions.

TABLE 1

| | | | | | | C═C | Amount |
|---|---|---|---|---|---|---|---|
| | Vinyl- | Silicone | | Viscosity | Iodine | content | of (I) |
| | siloxane | oil g | Condensate g | mm²/s | number | meq/g | mol % |
| Siloxane | 472 | — | 4.2 | 290 | 6.4 | 0.25 | 0.4 |
| 1.1 | | | | | | | |
| Siloxane | 472 | — | 12.6 | 216 | 9.7 | 0.38 | 1.2 |
| 1.2 | | | | | | | |
| Siloxane | 472 | — | 37.8 | 222 | 16.7 | 0.66 | 3.6 |
| 1.3 | | | | | | | |
| Siloxane | 236 | 236 | 19.6 | 218 | 8.3 | 0.33 | 1.9 |
| 1.4 | | | | | | | |

Comparison polymers:

### Siloxane C1:

Branched siloxane polymer with vinyl end groups, prepared according to WO 2007/023084, with an iodine number of 54 (C═C content of 2.13 meq/g).

### Siloxane C2:

Linear polydimethylsiloxane with vinyl and methyl end groups in a ratio of 3.5:1, and an iodine number of 5.4 (C═C content of 0.21 meq/g), according to U.S. Pat. No. 6,274,692.

### Siloxane C3:

Branched siloxane polymer with 5-hexenyl groups and 1,6-hexanediyl bridges according to U.S. Pat. No. 5,241,034, prepared from the hydrogen precursor HMe₂SiO(Me₂SiO)₆₃(HMeSiO)_{0,9}SiHMe₂ and 1,5-hexadiene with a C═C/SiH ratio of 3.2 (Y═—(CH₂)₆—, R¹═—(CH₂)₄—CH═CH₂, R═—CH₃, a=1, b=2, c=2 or 3). The iodine number is 10.4 (C═C content of 0.41 meq/g).

### Siloxane C4:

Linear polydimethylsiloxane with vinyl end groups and an iodine number of 4.1 (C═C content of 0.16 meq/g).

### Silicone Coating Compositions:

In the application examples below, all references to parts and percentages are by weight. The examples were carried out under the pressure of the surrounding atmosphere, in other words approximately at 1012 mbar, and at room temperature, in other words approximately at 21° C. The viscosities were measured at 25° C.

### Examples and Comparative Experiments:

The standard formulation used was a mixture of

100 parts by weight of each of inventive polymers siloxane 1.1-1.4 and of the comparison polymers siloxane C1-C4,

a linear hydrogenmethylsiloxane having trimethylsiloxane end units and a viscosity of 25 mPa·s (25° C.), in an amount ensuring a molar ratio of the SiH groups to the unsaturated groups of the respective polymer of 1.6:1,
1 part by weight of a 1% strength by weight (based on elemental platinum) solution of a platinum-1,3-divinyl-1,1,3,3-tetramethyldisiloxane complex in an α,ω-divinyldimethylpolysiloxane having a viscosity of 1000 mPa·s at 25° C., and 0.25 part by weight of 1-ethynylcyclohexanol.

These mixtures were used for coating paper. The substrate used was paper from Ahlstrom bearing the designation Glassine Silca Classic. Coating took place on a Dixon coating unit of model number 1060 with a 5-roll applicator mechanism, at 60 m/min. The coating was cured at 140° C. in a drying oven with a length of 3 m. This corresponds to a crosslinking time of 3 seconds.

The coating weight was determined by means of X-ray fluorescence analysis in reference to an appropriate standard.

The curing of the coating system was determined by extracting noncrosslinked fractions in MIBK (i.e., methyl isobutyl ketone) and determining the extracted silicon content by means of atomic absorption spectrometry.

In an experiment the coated papers had the test adhesive tapes TESA T 6154 and TESA A 7475, common in the labels and adhesive tape industry, adhered to them after 24 hours, and were then stored in accordance with FINAT Test method FTM 10 under a pressure of 70 g/cm² at 40° C. for 20 hours.

The release values of the laminates produced in this way were determined in accordance with FINAT Test method FTM 10, with removal speeds of 0.3 m/min., 10 m/min., and 300 m/min., and reported in N/m.

The test methods are described in the DEHESIVE® Silicones test methods brochure from Wacker Chemie AG and in the FINAT Technischen Handbuch (test methods), 6th edition.

The results are summarized in table 2.

TABLE 2

| | | | Release values | | | Release values | | |
|---|---|---|---|---|---|---|---|---|
| | C═C | | A 7475 | | | T 6154 | | |
| | content | Extract | 0.3 | 10 | 300 | 0.3 | 10 | 300 |
| Polymer | meq/g | wt. % | m/min. | m/min. | m/min. | m/min. | m/min. | m/min. |
| Siloxane | 0.25 | 2.2 | 7.1 | 7.2 | 7.9 | 2.2 | 5.4 | 9.4 |
| 1.1 | | | | | | | | |
| Siloxane | 0.38 | 1.2 | 7.9 | 6.2 | 8.0 | 3.4 | 5.5 | 8.8 |
| 1.2 | | | | | | | | |
| Siloxane | 2.13 | 0.8 | 178 | 53.2 | 22.4 | 101 | 39.2 | 11.7 |
| C1 | | | | | | | | |
| Siloxane | 0.33 | 3.8 | 2.5 | 4.2 | 9.3 | 1.0 | 2.3 | 8.9 |
| 1.4 | | | | | | | | |
| Siloxane | 0.21 | 11.9 | 5.3 | 9.2 | 16.6 | 0.6 | 3.0 | 13.9 |
| C2 | | | | | | | | |

With very low extraction values, the inventive formulations with the siloxanes 1.1 and 1.2 exhibit surprisingly low release values with respect to the two test adhesive tapes but these values can no longer be realized in the case of the high vinyl content of the comparison polymer siloxane C1 (according to WO 2007/023084), even when the siloxane C1 contains the same structural elements.

Formulations based on siloxanes with additional methyl end groups (siloxane 1.4) also produce lower release values in comparison to siloxanes 1.1 and 1.2 with 100% alkenyl ends, especially at a lower rate of removal, with a fundamentally higher level of extract. In comparison to the partially methyl-terminated siloxane C2 (according to U.S. Pat. No. 6,274,692), the likewise partially methyl-terminated siloxane 1.4, with a very acceptable extract level, again exhibits reduced release values in comparison to the prior art.

As described above, coatings were produced with the inventive polymers siloxanes 1.2 and 1.3 and also with the comparison polymers siloxane C3 and siloxane C4, and these coatings were crosslinked at a temperature of 140° C. for 6 seconds or 1.2 seconds. The curing of the coatings was determined by means of extraction of noncrosslinked fractions in MIBK, as described above, and the extraction values are summarized in table 3.

TABLE 3

| | C═C | Extract after | Extract after |
|---|---|---|---|
| | content | 6 sec./140° C. | 1.2 sec./140° C. |
| Polymer | meq/g | wt. % | wt. % |
| Siloxane | 0.38 | 1.2 | 7.4 |
| 1.2 | | | |
| Siloxane | 0.66 | 0.9 | 2.8 |
| 1.3 | | | |
| Siloxane C3 | 0.41 | 2.2 | 5.0 |
| Siloxane C4 | 0.16 | 2.6 | >30 |

In comparison to the two formulations with comparison polymers siloxane C3 and C4, the fully vulcanized formulations (6 sec. cure time) with the inventive siloxanes 1.2 and 1.3 exhibit a perfectly low extract level of only about half the value of the comparison formulations. Although the formulation with the hexenyl siloxane C3 (according to U.S. Pat. No. 5,241,034) also has a high crosslinking rate (as evident from the extract value after 1.2 sec. cure time), it nevertheless fails in the fully vulcanized silicone coating (6 sec. cure time) to attain the very good extract level of inventive formulations. The linear comparison polymer C4 is inferior to the inventive siloxanes 1.2 and 1.3 both at 1.2 sec. cure time and at 6 sec. cure time.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A crosslinkable silicone coating composition comprising
(1) organopolysiloxane(s) containing alkenyl groups and comprising per molecule at least one structural unit of the formula
O_{3-n/2}RₙSi—Y(SiRₙO_{3-n/2})ₐ (I),
at least 2 units of the formula
R¹R_{b}SiO_{(3-b)/2} (II),
and units of the formula
R_{c}SiO_{(4-c)/2} (III),
where
a is 1 or 2,
b is 0, 1 or 2,
c is 1, 2 or 3,
n is 0 or 1,
R at each occurrence may be identical or different and is a monovalent, SiC-bonded organic radical having 1 to 30 C atoms, optionally containing one or more nonadjacent O atoms and which is free from aliphatic carbon-carbon multiple bonds, and
R¹ is an alkenyl radical having 2 to 4 C atoms, preferably a vinyl radical,
Y is a divalent or trivalent organic radical having 1 to 30 C atoms,
with the proviso that the organopolysiloxanes (1) comprise units of the formula (II) in molar amounts such that the concentration of alkenyl radicals R¹ in organopolysiloxanes (1) is less than 2 meq/g,
(2) organopolysiloxanes containing Si-bonded hydrogen atoms,
(3) at least one catalyst which promotes the addition of Si-bonded hydrogen to an aliphatic multiple bond, and
(4) optionally, inhibitors.

2. The crosslinkable silicone coating composition of claim 1, wherein R¹ is a vinyl radical.

3. The crosslinkable silicone coating composition of claim 1, wherein Y is a radical of the formula —CH₂CH₂—.

4. The crosslinkable silicone coating composition of claim 1, wherein b is 2 and c is 2 or 3.

5. A molding produced by crosslinking a composition of claim 1.

6. The molding of claim 5, which is a coating.

7. The molding of claim 5, which is a coating which repels tacky substances.

8. A process for producing a coating on a surface comprising applying a crosslinkable composition of claim 1 to the surface to be coated and then crosslinking the composition.

9. A process for producing a coating on a surface which repels tacky substances, comprising applying a crosslinkable composition of claim 1 to the surface to be made repellent to tacky substances and then crosslinking the composition.
